(19) United States
(12) Patent Application Publication
(10) Pub. No.: US 2014/0238927 A1
(43) Pub. Date: Aug. 28, 2014

(54) Liquid Filter

(71) Applicant: MANN+HUMMEL GMBH, Ludwigsburg (DE)

(72) Inventor: Mathias Volk, Otterstadt (DE)

(73) Assignee: MANN+HUMMEL GMBH, Ludwigsburg (DE)

(21) Appl. No.: 14/193,939

(22) Filed: Feb. 28, 2014

(30) Foreign Application Priority Data
Feb. 28, 2013 (DE) 10 2013 003 305.5

(51) Int. Cl. B01D 29/05; B01D 29/00

(52) U.S. Cl. CPC B01D 29/05; B01D 29/0093
USPC 210/484; 29/446

(57) ABSTRACT

The invention concerns a filter element for liquids, in particular for cooling, lubricating or processing liquids, including a filter body, in particular formed of a flat filter medium, surrounding an interior, having two end faces that along a longitudinal axis are spaced apart, and having an outer outflow surface, and further comprising a liquid-permeable, elastic, in particular porous, cover for reducing spraying that is stretched across the filter body and encloses its outflow surface substantially completely.

### CROSS-REFERENCE TO RELATED APPLICATIONS

This application claims the benefit of German patent application DE 10 2013 003 305.5 filed Feb. 28, 2013, the entire contents of the aforesaid German patent application being incorporated herein by reference.

### TECHNICAL FIELD

The invention concerns a filter element for liquids, in particular for cooling, lubricating or processing liquids of machine tools, for example, eroding machines.

### BACKGROUND

DE 20 2005 014 690 U1 discloses such a filter element for use in a filter housing. The filter element described therein has a filter medium that is folded in a zigzag shape and is of closed annular configuration. The filter element described therein is flowed through from the interior to the exterior. In order to prevent that, when a certain pressure is surpassed, pockets will form between the folds of the filter medium which can lead to uncontrolled spraying of cleaned liquid from the support body, it is proposed in DE 20 2005 014 690 U1 to attach to the support body means for a substantially spray-free drainage. As such a means, through passages extending through the support body are to be provided with a passage contour of a complex shape that effects a deflection of the filtered liquid.

### SUMMARY OF THE INVENTION

The object of the invention is therefore to provide a liquid filter element which is improved with respect to spray protection and manufacture.

This object is solved by a filter element for liquids, in particular for cooling, lubricating or processing liquids of the aforementioned kind, comprising a filter body, that is formed in particular of a flat filter medium, surrounds an interior, has two end faces that are spaced apart along a longitudinal axis, and has a radial outer outflow surface, and further comprising a liquid-permeable, elastic, in particular porous, cover for reducing spraying, the cover stretched across the filter body and enclosing the filter body's outflow surface substantially completely.

This has the advantage that the cover, as soon as it has been stretched across the filter body, contributes to the filter body' shape stability and, at the same time, represents an effective and inexpensive spray protection in operation of the filter element.

In a preferred embodiment, the cover covers or stretches across one or two end faces partially or completely. This can contribute, for example, to a further stabilization of the filter body and, as described infra, can facilitate manufacture of the filter element. Moreover, in this way, it is not required that the cover is perfectly tailored because fulfilling a narrow tolerance relative to the amount of projecting length is not required.

In one embodiment, the cover is made of an elastic, liquid-permeable, flaccid textile material, for example, a woven fabric, a warp knit fabric, weft knit fabric, braided material, stitch-bonded material, nonwoven or felt. Suitable are in this context those textile materials that are liquid-stable relative to the liquid to be filtered, preferably cooling, lubricating or processing liquids of machine tools, for example, eroding machines. The textile material, in one embodiment, can be formed, for example, of an elastomer, a thermoplastic material and preferably formed of a polyamide, for example, polycaprolactam, poly-(N,N′-hexamethylene adipine diamide), poly-(hexamethylene adipamide), poly-(hexamethylene sebacamide), poly-(hexamethylene dodecane diamide), polyundecanolactam or polylauryllactam.

The cover has preferably a weight per surface area in the unstretched state of 100 to 200 g/m², preferably between 125 and 175 g/m². Moreover, when using a fabric, it is preferred to have a thread density in the unstretched state between 4 and 20 threads per centimeter, preferably between 10 and 15 threads per centimeter, and the stitch gauge should be 10-48 E, preferably between 15 and 38 E, in case of using a knit material.

In a preferred embodiment, it is provided that the cover is formed as an elastic textile hose or sock with one or two open ends. This has the advantage that the latter, during manufacture of the filter element, can be simply pulled and stretched with an open end across the filter body. Preferably, the open end or ends are positioned such about the filter body that an inflow opening of the filter element that is connected to the interior, for example, provided in one end disk, is surrounded by an open end and, in this way, the cover does not cover the inflow opening and/or the interior at one end face of the filter body.

In a preferred embodiment, it is provided that the filter element furthermore comprises one or two end disks that are connected to the end faces of the filter body wherein between filter body and end disks a seal-tight connection is provided so that the end disks seal-tightly close off the end faces of the filter body. More preferred, in one or both end disks an inflow opening for the fluid to be filtered is provided through which the fluid can pass into the interior of the filter body.

In one embodiment, one or both end disks can be formed of a potting compound of a pourable plastic material such as polyurethane in which the filter body is embedded positively and seal-tightly in that during manufacture of the end disk it is immersed into the still liquid or viscous material of the end disk, for example, in a casting bowl.

The potting compound has preferably a relatively great hardness of greater than Shore 40D, preferably greater than Shore 50D, particularly preferred greater than Shore 60D, and, further preferred, is not foamed or only minimally foamed. This has the advantage that, after casting, the material will shrink only minimally.

In one embodiment, one or both end disks can be formed also of an injection-molded plastic material such as polyamide, polyamide with glass fiber admixture or a sheet metal and connected seal-tightly in a different way with the filter body. For example, the seal-tight connection at one or both end disks can be realized by means of an adhesive or by means of a weld connection in case of an end disk of a thermoplastic synthetic material.

In a preferred embodiment, it is provided that the seal-tight connection between filter body and end disks encloses the cover. This can be achieved in that the filter body during manufacture is first covered with the cover and, subsequently, the seal-tight connection with one or both end disks is produced wherein the cover covers and is stretched across one or both end faces in the area of the seal-tight connection. In this context, it is preferably achieved that the cover in this area is engaged and enclosed by the weld or adhesive connection or, together with the filter body, is enclosed or embedded in an end disk of castable material during the wend disk's manufacture.

In a preferred embodiment, it is provided that the filter element moreover comprises a fluid-permeable support body that surrounds the filter body and is in particular of a hollow cylindrical configuration in which preferably a plurality of holes with preferably substantially oval, in particular round, geometry are provided for passage of the liquid. This support body can protect the outflow surface from damage when handling the filter element; however, it serves substantially for supporting in particular the filter body, flowed through from the interior to the exterior, from the operating pressures that are generated thereby and in particular from radially outwardly acting forces.

In a preferred embodiment, it is provided that the end disks and/or the support body is formed of plastic material in particular by means of an injection molding process.

The invention concerns moreover a method for producing a filter element for liquids, in particular for cooling, lubricating or processing liquids, comprising the steps:
providing a filter body that is in particular formed of a flat filter medium, surrounding an interior, having two end faces that are spaced apart along a longitudinal axis, and having an outer outflow surface;
pulling a cover that is liquid-permeable, elastic, in particular porous, over the filter body for reducing splash in such a way that the cover is stretched across the filter body so that the cover encloses the outflow surface of the filter body substantially completely.

As a filter body, preferably a filter medium is used that is zigzag-folded multiple times. It can comprise, for example, layers on a cellulose basis, melt blown basis, glass fiber basis, spun nonwoven basis or multi-layer combinations thereof.

The filter body can be folded in a zigzag shape and a star shape and can have an annular closed configuration. The filter body can also be comprised of three or more fold bellows whose fold edge length is preferably variable. In this way, the surface area available for the passage of liquid can be significantly increased. In this context, the length of the fold edges typically increases, beginning at oppositely positioned ends of each fold bellows, toward a central area where the fold edge length is at its maximum.

In order to enable a discharge as uniform as possible of the cleaned liquid from the filter element or the support body, it is beneficial to arrange the fold bellows with rotational symmetry relative to a center axis of the hollow cylindrical support body. Typically, the support body has a circular cylindrical shape but it is understood that also cylindrical support bodies that have a geometry deviating from a circular cross-sectional surface can be employed for the present applications.

It has been found that upon use of three or more fold bellows the support of the filter element in axial direction can be realized exclusively by the fold bellows and the support bodies enclosing the fold bellows. In particular when the support body is made of a plastic material, no additional central tube extending in axial direction and surrounded by the filter medium is required for absorbing tensile force.

For supply of liquid, the folded bellows are preferably designed such or arranged such within the support body, that between the fold bellows passages are produced which extend in radial direction in the direction toward the support body, in particular up to the support body. By means of the passages, the liquid, which is usually entering the filter element through one or several central openings at the end disks, is preferably supplied to the fold bellows so that the surface of the fold bellows can be substantially completely utilized for filtration.

It has been found that it is beneficial to provide in the support body a plurality of holes with preferably substantially oval, in particular round, geometry for passage of the liquid. By means of the hole geometry, the occurring maximum tensions in the support body during filter operation can be significantly reduced. A substantially oval or round hole geometry is to be understood, aside from being a completely oval or round opening, in particular also as slotted holes which have two round or oval halves that are connected to each other by straight sections. In particular when using a support body of plastic material, the use of a substantially oval or round hole geometry has beneficial effects because in this case the thickness of the plastic material used for producing the support body can be significantly reduced.

In order to safe material and thus manufacturing costs, it is beneficial when the support body has a thickness of 5 mm or less, preferably of 3 mm or less. When using sheet metal as a material for the support body, such a thickness can be realized generally without a problem without there being the risk that the support body during operation of the filter element could be destroyed because of the pressure acting on it. However, support bodies of a plastic material can be also realized with such a minimal thickness, in particular in case that the hole geometry is selected as disclosed above so that the occurring maximum tensions within the support body can be significantly reduced.

In particular, for an even more improved prevention of spraying of filtered liquid, it is also possible to provide additionally at least one stabilizing element, respectively, on the fold bellows in the circumferential direction for stabilization of the fold edges, in particular in the form of a circumferentially extending (glue) strip. By means of the stabilizing element(s), the fold edges can be secured at a defined spacing to each other. In this way, the formation of pockets between neighboring folds of the fold bellows are avoided and, in this way, an uncontrolled clean-side spraying of liquid can be prevented even better.

In a preferred embodiment of the filter element, the fold bellows are connected to each other in particular by an adhesive. The attachment of the fold bellows to each other is done generally at their tapering pointed ends in that they are connected to each other in an overlap area. Due to this connection, the fold bellows are formed to an annularly closed filter body so that the raw side can be separated in a particularly simple way from the clean side. In particular, the thus formed annularly closed filter body can be inserted in a particularly simple way into the support body and secured thereat. It is understood that, optionally, the fold bellows can also be arranged in the support body without being mutually connected. In this case, the fold bellows are typically spaced apart from each other in circumferential direction wherein between the fold bellows, as disclosed above, passages are formed. In the circumferential area of the support body in which the passages are formed, the support body is impermeable for liquids in this case. The fold bellows must be sealed individually at their ends relative to the support body in this case in order to prevent passage of uncleaned liquid to the clean side.

Further features and advantages of the invention result from the following description of embodiments of the invention, from the Figures of the drawing that show important details of the invention, and form the claims. The individual features can be realized individually or several of them in any combination can be realized in variants of the invention.

### BRIEF DESCRIPTION OF THE DRAWINGS

Embodiments are illustrated in the schematic drawing and will be explained in the following description. It is shown in:

FIG. 1 a cross-section of an embodiment of the filter element;

FIG. 2 a side view of the filter element of FIG. 1;

FIG. 3 a side view of a second embodiment of the filter element;

FIG. 4 a cross-section of the filter element of FIG. 3; and

FIG. 5 a detail of an alternative embodiment of the end disks of one of the preceding embodiments.

### DETAILED DESCRIPTION

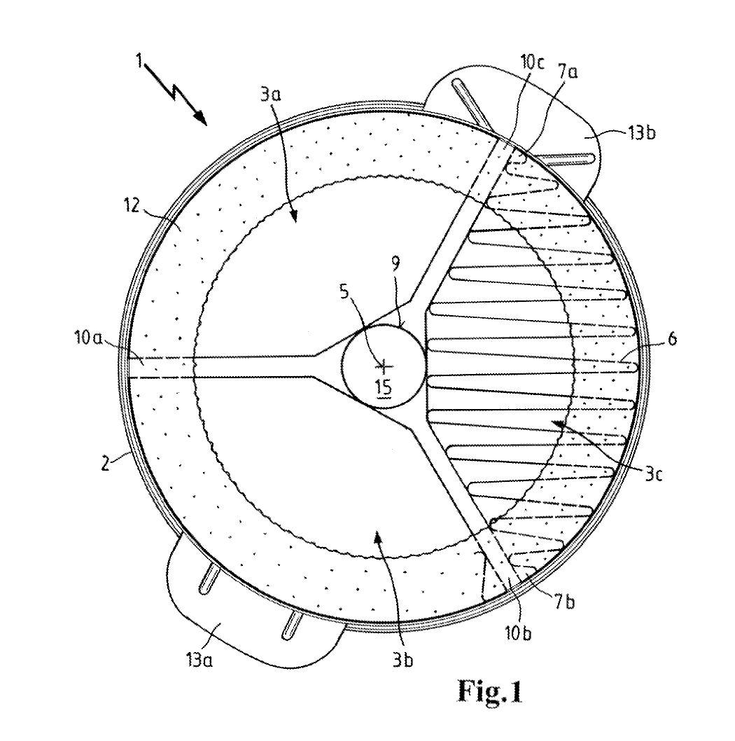

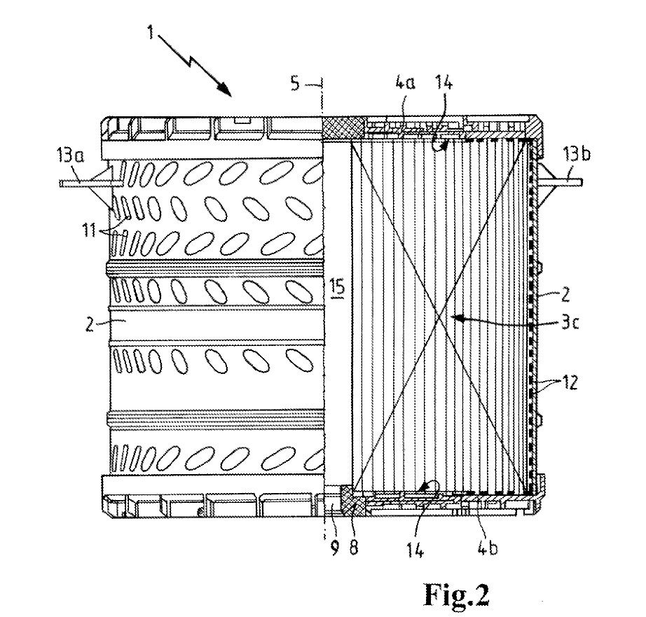

In FIG. 1 and FIG. 2 a filter element 1 is illustrated that is suitable for filtration of liquids, in particular cooling, lubricating or processing liquids of machine tools, for example, of eroding machines, and it is insertable into a filter housing (not illustrated).

The filter element 1 has a circular cylindrical support body 2 of plastic material within which a filter body is arranged that is comprised of three fold bellows 3a, 3b, 3c. The filter body surrounds an interior 15 which surrounds the center axis 5. As can be seen in FIG. 2, the filter element 1 has two end disks 4a, 4b each having a receiving area for the filter bellows 3a-3c where they can be attached e.g. with the aid of an adhesive or by welding in order to fix the position of the fold bellows 3a-3c relative to the support body 2.

The fold bellows 3a-3c have identical geometry and are arranged with rotational symmetry relative to a central axis 5 of the hollow cylindrical support body 2 wherein each fold bellows 3a-3c covers in circumferential direction an angle range of approximately 120°. Each one of the fold bellows 3a-3c is comprised of a zigzag-shape folded filter paper of synthetic material with a plurality of fold edges 6 of which only a few are shown in FIG. 1 in an exemplary fashion. As indicated at one of the fold bellows 3c, the length of the fold edges 6 between neighboring fold tips increases toward the central area, starting at two oppositely positioned tapering pointed ends 7a, 7b.

As in the section illustration on the right side of FIG. 2, the lower end disk 4b has a seal 8 for sealing relative to a filter housing wherein in the seal 8 a central opening 9 is formed for supply of liquid to be purified, for example, contaminated water, into the interior of the filter element 1, i.e., the interior of the filter body. As can be seen in FIG. 1, the liquid which is centrally entering at the raw side through the opening 9 can continue to flow along passages 10a-10c that are formed between the fold bellows 3a-3c and extend radially outwardly to the support body 2 so that the entire raw-side surface of the fold bellows 3a-3c can be utilized for filtration.

In order to separate the raw side of the fold bellows 3a-3c from the clean side which is facing the support body 2, the fold bellows project in the area of their ends 7a, 7b, i.e., adjacent to the support body 2, into the passages 10a-10c where neighboring fold bellows 3a-3c overlap and, in the overlap area (adjacent to the support body 2), are adhesively connected to each other. It is understood that the fold bellows 3a-3c must not be mandatorily connected to each other but can also be individually sealed relative to the liquid-permeable support body 2 in order to separate the raw side from the clean side.

For passage of the liquid, in the support body 2 passage holes 11 are provided which in the present case are designed as a round and slotted holes, i.e., they are comprised of two half circles that are connected to each other by a straight section.

In order to avoid uncontrolled spraying of cleaned liquid from the support body 2, on the filter body which is formed of the three fold bellows 3a, 3b, 3c a cover 12 is attached which is comprised of a liquid-permeable, elastic, and porous textile material, for example, a knit material of polyamide. The textile material can also be present in the form of a woven fabric, warp knit fabric, weft knit fabric, braided material, stitch-bonded material, nonwoven or felt. The cover 12 surrounds substantially completely the outflow surface that is formed at the radial outer circumference of the filter body 3. Preferably, it covers or is stretched across both end faces partially or completely; as illustrated in the Figures in a view of the exterior. it stretches across approximately ⅓ of the radial extension of the filter body. The cover 12, as in the illustrated embodiment, can be designed as an elastic textile hose with two open ends in the area of the end disks 4a, 4b.

In addition, an uncontrolled spraying of the cleaned liquid can be reduced or avoided in a better way in that for stabilizing the fold edges in the circumferential direction at least one stabilizing element is employed, for example, in the form of one or several circumferentially extending (glue) strips (not illustrated). This makes it possible to secure the fold edges even during filter operation at a constant spacing to each other.

Between the two end disks (4a, 4b) arranged at the end faces of the filter body and the filter body that is formed of the three fold bellows 3a, b, c, a seal-tight connection 14 is provided so that the end disks seal at the end faces of the filter body seal-tightly. In the illustrated embodiment, this construction 14 is preferably in the form of a weld connection, i.e., the end disks at their inner sides are heated to the softening point and preferably to the melted state at the surface and the filter body is pressed into the softened or melted surface and is embedded fixedly and seal-tightly in the material of the end disk upon hardening.

As an alternative, one or both end disks 4a, b could be formed of a material which in the processable state is liquid or viscous, such as polyurethane (foam), into which the filter body 3 is then sealed-tightly embedded.

In the embodiment illustrated in FIGS. 1 and 2, the seal-tight connection 14 between filter body and end disks encloses the cover 12 so that the cover 12 is non-detachably connected to the end disks 4a, 4b and a radially outwardly exiting flow will not cause the detachment of the cover 12, even in the absence of the support body 2.

As also shown in FIGS. 1 and 2, the filter element 1 has no central tube for a support action as the support action of the filter element 1 in axial direction is exclusively realized by the filter medium, i.e., the folded bellows 3a-3c as well as the outer support body 2. Eliminating the central tube is in particular possible when using a plastic material for the support body 2 (as well as for the end disks 4a, 4b) because in this case the central tube is no longer required as a tensile force absorption means. As can be seen also in FIGS. 1 and 2, grips 13a, 13b are formed on the support body 2 for a simplified handling of the filter element 1.

In summarizing the above, in the afore described way a filter element 1 can be provided that can be produced, including a spray protection cover 12, in a simple and inexpensive way.

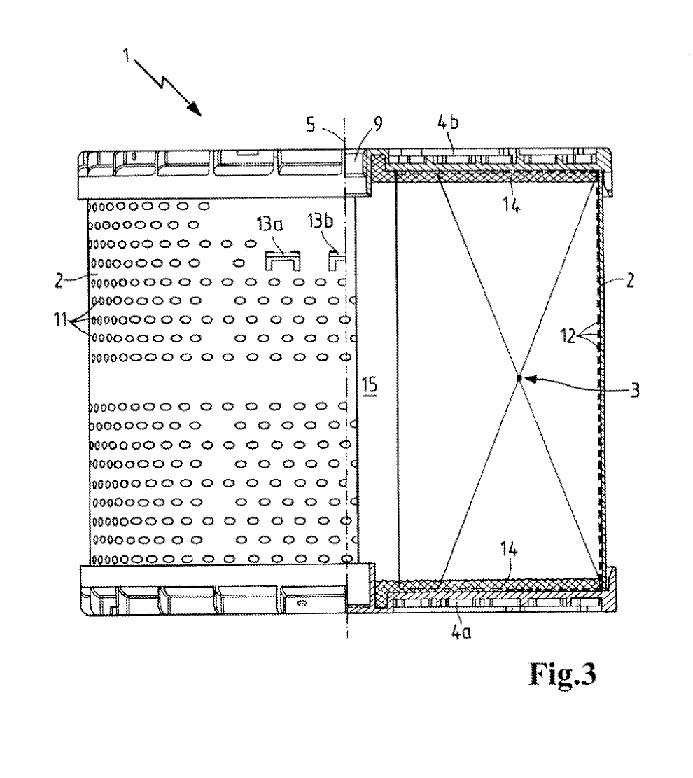

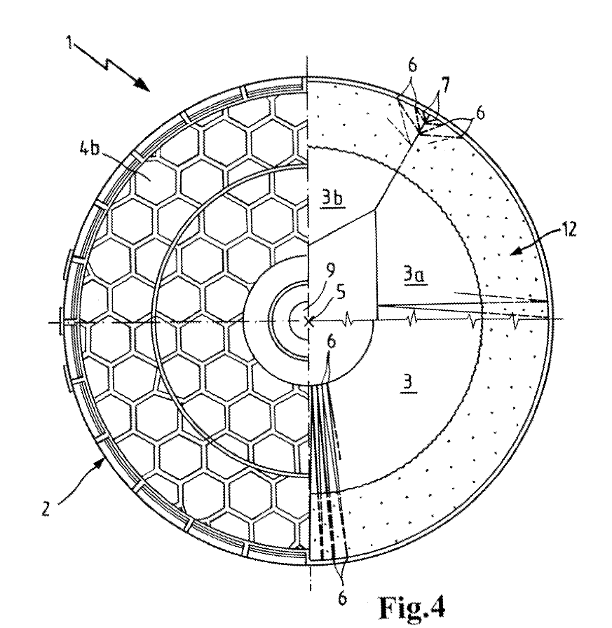

In FIGS. 3 and 4, a filter element 1 is shown that is designed for filtration of liquids, in particular of cooling, lubricating or processing liquids of machine tools, for example, of eroding machines, and is insertable into a filter housing (not illustrated). The embodiment illustrated in FIGS. 3 and 4 is similar in many ways to that of FIGS. 1 and 2 so that same or similar elements are identified with same reference characters.

The filter element 1 has optionally a circular cylindrical support body 2 of plastic material in which a filter body is inserted. The latter, as indicated in the upper part of FIG. 4, can be comprised of three fold bellows 3a, 3b, 3c or, as indicated in the lower part of FIG. 4, can be comprised of an annularly closed, star-shape fold bellows 3. As can be seen in FIG. 3, the filter element 1 has two end disks 4a, 4b that have a respective receiving area for the filter body 3 where the latter, for example, by means of an adhesive or by welding, can be attached in order to fix the position of the filter body 3 relative to the support body 2.

As shown in the section illustration on the right side of FIG. 3, the upper end disk 4b has a central opening 9 provided with a connecting thread for supply of liquid to be cleaned, for example, of contaminated water, which opening is in fluid communication with the interior of the filter element 1 or the interior 15 that is enclosed by the filter body 3. For exit of liquid, the support body 2 has passage holes 11 which in the present case are designed as round and slotted holes, i.e., the passage holes 11 are comprised of two half circles that are connected to each other by a straight section.

In order to avoid an uncontrolled spraying of the cleaned liquid from the support body 2, a cover 12 is stretched across the filter body 3 and is comprised of a liquid-permeable, elastic, and porous textile material, for example, is comprised of a knit material of polyamide. The textile material can also be in the form of, for example, a woven fabric, warp knit fabric, weft knit fabric, braided material, stitch-bonded material, nonwoven or felt. The cover 12 surrounds substantially completely the outflow surface formed at the radial outer circumference of the filter body 3. Preferably, the cover 12 covers or stretches across both end faces partially or completely; as illustrated in the Figures in a view of the exterior, it stretches across approximately one third of the radial extension of the filter body. The cover 12, as illustrated in the embodiment, can be formed by an elastic textile hose with two open ends in the area of the end disks 4a, 4b.

In addition, an uncontrolled spraying of the cleaned liquid can be avoided in that for stabilizing the fold edges in circumferential direction at least one stabilizing element is used, for example, in the form of one or several circumferentially extending (glue) strips (not shown). This makes it possible to secure the fold edges even during filter operation at a constant spacing to each other.

Between the two end disks (4a, 4b) arranged at the end faces of the filter body and the filter body which is formed of the three fold bellows 3a, b, c, a seal-tight connection 14 is provided so that the end disks seal-tightly close off the end faces of the filter body. The seal-tight connection is formed in the illustrated embodiment preferably as an adhesive connection, i.e., the filter body is fixedly and seal-tightly embedded by the adhesive at the end faces that are facing the end disks 4a, 4b and is connected to the end disks 4a, 4b.

As an alternative, one or both end disks 4a, 4b can be formed of a material that in the processable state is liquid or viscous, for example, a polyurethane (foam), in which the filter body is seal-tightly embedded.

In the embodiment illustrated in FIGS. 3 and 4, the adhesive 14 encloses the cover 12 between filter body and end disks so that the cover 12 is non-detachably connected to the end disks 4a, 4b and a radially outwardly exiting flow will not cause detachment of the cover 12, even without the presence of a support body 2.

As is shown also in FIGS. 3 and 4, the filter element 1 has no central tube as a support because the support action of the filter element 1 in axial direction is realized exclusively by the filter medium, i.e., the fold bellows 3a-3c as well as by the outer support body 2. However, for increased stability requirements, a central tube can be provided which is preferably connected fixedly with the end disks 4a, 4b. Eliminating the central tube is in particular possible when using a plastic material for the support body 2 (as well as for the end disks 4a, 4b) because in this case the central tube is no longer required as a tensile force absorption means. As illustrated also in FIGS. 3 and FIG. 4, grips 13a, 13b are formed on the support body 2 for simplified handling of the filter element 1.

In summarizing the above, in the afore described way, a filter element 1 can be provided that can be produced, including a spray protection cover 12, in a simple and inexpensive way.

The above described filter elements 1 are preferably produced in that first a filter body 3, 3a, b, c, formed in particular of a flat filter medium, surrounding an interior, having two end faces that are spaced from each other along a longitudinal axis 5, and having an outer outflow surface, is provided and, subsequently, a liquid-permeable elastic, porous cover 12 for reducing spraying is stretched across the filter body 3 in such a way that the cover 12 encloses the outflow surface of the filter body 3 substantially completely. The thus formed unit, in comparison to filter bodies 3 without cover 12, is significantly more shape-stable so that also handling and the further processing steps, for example, the connection of the end disks or the introduction of the filter body into the support body 2, are facilitated. Preferably, the filter body together with the stretched-across cover 12 is subsequently introduced into a support body 2. This unit is then preferably subsequently seal-tightly connected with the end disks 4a, b by means of a seal-tight connection 14 in accordance with one of the alternatives disclosed in the disclosure, wherein preferably the cover 12 in the area of the end disks 4a, b and/or in the area of the end faces of the filter body facing the end disks 4a, b is enclosed by the material of the seal-tight connection 14, i.e., by the melted or not yet hardened end disk material or by the adhesive.

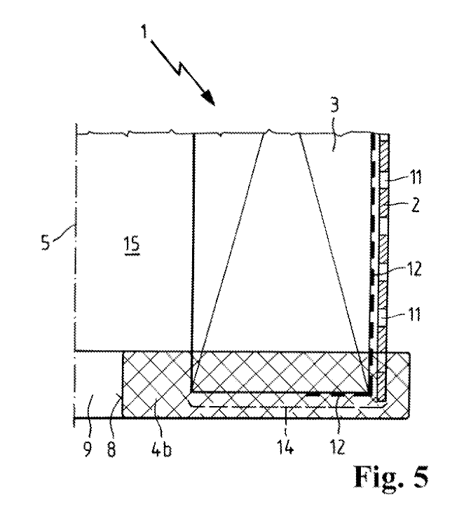

FIG. 5 shows a detail of an alternative embodiment of the end disks 4a, b of a filter element 1. The end disk (here 4b) is formed of a material which in the processable state is liquid or viscous, in this embodiment by a castable polyurethane, in which the filter body 3, the cover 12 that stretches across the filter body, and preferably also the support body 2 are seal-tightly embedded. In this way, closed end disks as well as the end disk 4b with a central opening 9, as illustrated, can be formed, wherein, in this way, a radial inwardly oriented sealing surface 8 can be automatically formed also upon manufacture of the end disk 4b by casting a polyurethane potting compound in a casting bowl. In this example, the cover 12 also stretches across the axial end face of the filter body 3 which is embedded in the end disk 4b and is in this area also embedded in the seal-tight connection 14 which is formed by the end disk material itself.

1. A filter element (1) for liquids, comprising:
a filter body formed of a flat filter medium, the filter medium radially surrounding an open interior, the filter body having two opposing axial end faces that along a longitudinal axis are spaced apart, and having a radially outer outflow surface;
a cover that is liquid-permeable, elastic and porous, for reducing spraying, the cover stretched across the filter body and enclosing its outflow surface substantially completely.

2. The filter element according to claim 1, wherein
the cover partially or completely covers or stretches across one or both end faces.

3. The filter element according to claim 1, wherein
the cover is formed of an elastic, liquid-permeable, flaccid textile material, selected from the group including: a woven fabric, warp knit fabric, weft knit fabric, braided material, stitch-bonded material, nonwoven or felt.

4. The filter element according to claim 1, wherein
the cover is embodied as an elastic textile hose or sock with one or two open ends.

5. The filter element according to claim 1, further comprising
one or two end disks (4a, 4b) arranged on and secured onto the end faces on the filter body;
wherein between filter body and end disks a seal-tight connection is provided so that the end disks seal-tightly close off the end faces of the filter body.

6. The filter element according to claim 5, wherein
the seal-tight connection at one or both end faces is realized by means of an adhesive or is produced in that one or both end disks are formed of a material, which in the processable state is liquid or viscous, into which the filter body is embedded seal-tightly.

7. The filter element according to claim 6, wherein the seal-tight connection between filter body and end disks encloses the cover.

8. The filter element according to claim 5, further comprising
a hollow cylindrical support body (2) that is fluid-permeable and surrounds the filter body, in which a plurality of through holes (11) with are provided for passage of the liquid.

9. The filter element according to claim 8, in which the end disks (4a, 4b) and/or the support body (2) are/is formed of plastic material;
wherein the end disks (4a, 4b) and/or the support body (2) are/is formed by an injection molding process.

10. A method for producing a filter element for liquids, comprising the steps of:
providing a filter body, in particular formed of a flat filter medium, surrounding an interior, having two end faces that along a longitudinal axis are spaced apart, and having an outer outflow surface;
pulling a cover that is liquid permeable, elastic, in particular porous, over the filter body for reducing spraying of the filter body in such a way that the cover is stretched across the filter body so that the cover substantially completely encloses the outflow surface of the filter body.
